(19) United States
(12) Patent Application Publication
(10) Pub. No.: US 2004/0213577 A1
(43) Pub. Date: Oct. 28, 2004

(54) Optical transmission line and optical transmission system

(75) Inventor: Hiroto Sugahara, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/784,827

(22) Filed: Feb. 24, 2004

(30) Foreign Application Priority Data
Apr. 22, 2003 (JP) 2003-117128

(51) Int. Cl. H04B 10/12

(52) U.S. Cl. 398/147

(57) ABSTRACT

An optical transmission line is partitioned into a plurality of spans by a plurality of optical amplification repeaters. A transmission span is provided with a plurality of dispersion compensation elements for compensating for wavelength dispersion caused by the transmission line fiber. The dispersion compensation elements substantially do not increase the length of the span in which they are located. One of the pluralities of dispersion compensation elements is arranged in the optical amplification repeater.

### CROSS-REFERRENCES TO RELATED ALLICAIONS

The disclosure of Japanese Patent Application No. JP2003-117128 filed on Apr. 22, 2003 including the specification, drawings and abstract is incorporated herein by reference in its entirety.

### BACKGROUND OF THE INVENTION

1. Field of the Invention

The present invention relates to an optical transmission line and optical transmission system having dispersion compensation performed in its transmission line and particularly to a high-speed and long-distance wavelength division multiplexed (WDM) an optical transmission line and optical transmission system of 40 Gbps or higher in transmission rate per channel and 1000 km or longer in transmission distance.

2. Description of Related Art

In recent years, research and development of a long-distance WDM transmission have been actively performed. An example of such a technique has been disclosed in the following [Patent literature 1] and [Non-patent literature 1] to [Non-patent literature 3].

The conventional techniques described above have disclosed a configuration provided with a dispersion compensation means for compensating for wavelength dispersion of a transmission line fiber between optical amplification repeaters arranged in a transmission line.

FIG. 10(A) shows a dispersion map in a transmission span in a transmission line configuration disclosed in [Non-patent literature 1]. In this configuration, a single pure silica core fiber (PSCF) having a positive wavelength dispersion value and a single dispersion compensation fiber (DCF) having a negative wavelength dispersion value are connected to each other in this order in a transmission span between optical amplification repeaters.

FIG. 10(B) shows a dispersion map in a transmission span in a transmission line configuration disclosed in [Non-patent literature 2]. In this configuration, a single DCF is arranged between two PSCFs.

FIG. 10(C) shows a dispersion map in a transmission span in a transmission line configuration disclosed in [Patent literature 1]. The configuration of [Patent literature 1] is obtained by substituting a substantially linear dispersion and dispersion slope compensation device for a DCF in [Non-patent literature 2]. As one of features of the techniques disclosed in the above-mentioned [Non-patent literature 1], [Non-patent literature 2] and [Patent literature 1], such a fact is mentioned that only one dispersion compensation means (DCF or dispersion and dispersion slope compensation device) is arranged in a transmission span. Such a transmission line configuration has a large quantity of accumulated dispersion to be accumulated in a transmission span and provides good transmission characteristics in a WDM transmission of 10 Gbps, 20 Gbps or so in transmission rate per channel.

However, the wavelength dispersion in an optical fiber increases in proportion to the square of transmission rate per channel. Even in the same dispersion map configuration, therefore, the wavelength dispersion, which a signal of 40 Gbps is subject to, is 16 times larger than the wavelength dispersion, which a signal of 10 Gbps is subject to. Therefore, in case of transmitting a signal of 40 Gbps in a transmission line varying greatly in accumulated dispersion value in a transmission span like the transmission line configurations disclosed in the above-mentioned [Non-patent literature 1], [Non-patent literature 2] and [Patent literature 1], since the variation in accumulated dispersion value in a transmission line is too large, the waveform of a signal is greatly deteriorated due to an synergic effect of self phase modulation (SPM) and wavelength dispersion of an optical fiber.

Therefore, the technique disclosed in [Non-patent literature 3] uses a transmission line configuration repeating a large-A_{eff} pure silica core fiber (LAPSCF) and a DCF at plural times in each transmission span. FIG. 10(D) shows a dispersion map in a transmission span in the transmission line configuration disclosed in [Non-patent literature 3]. In this configuration, two DCFs and two LAPSCFs are arranged alternately with each other in a transmission span between optical amplification repeaters. A transmission line configuration in which a plurality of positive dispersion fibers and a plurality of negative dispersion fibers are connected alternately with each other in a transmission span in such a way is referred to as a multiple-hybrid span configuration. A multiple-hybrid span configuration can make the quantity of variation in accumulated dispersion value smaller than a single-hybrid span configuration as disclosed in [Non-patent literature 1], [Non-patent literature 2] and [Patent literature 1], and enables a long-distance transmission such as a transoceanic transmission even in a WDM transmission of 40 Gbps or higher in transmission rate per channel.

FIG. 11 shows details of a double-hybrid span configuration disclosed in [Non-patent literature 3]. An optical transmission line span 30′ is provided with LAPSCFs 5-1′, 5-2′ and DCFs 6-1′, 6-2′. A terminal of the transmission span 30′ is provided with an optical amplification repeater 4′, and the optical amplification repeater 4′ is provided with an excitation light source 41′ for performing a backward excitation Raman amplification and a WDM coupler 42′ for inputting an excited light generated from the excitation light source 41′ into the transmission line fiber 5-2′.

[Patent Literature 1]

Japanese Patent Laid-Open Publication No. 2002-280,959 (pp. 4-6, FIG. 1)

[Non-Patent Literature 1]

T. Naito et al., “1 terabit/s WDM transmission over 10,000 km”, European Conference on Optical Communication 1999, PD2-1, September 1999.

[Non-Patent Literature 2]

T. Tsuritani et al., “21.4 Gbit/s×56 WDM 9170 km transmission using symmetrical dispersion managed fiber span”, European Conference on Optical Communication 2001, PD.M.1.6, September 2001.

[Non-Patent Literature 3]

H. Sugahara et al., “9,000-km transmission of 32×42.7 Gb/s dense-WDM signals using 195-um2-Aeff fiber and inverse double-hybrid span configuration”, Optical Amplifier and their Applications 2002, PD3, July 2002.

However, the multiple-hybrid span configuration disclosed in [Non-patent literature 3] has the following two problems.

As the first problem, it is mentioned that it is not easy to perform optimization of a transmission line configuration which is needed due to change of an amplifying means. Referring to a conventional technique of [Non-patent literature 3], DCFs and LAPSCFs forming a transmission span are connected to each other in order of DCF+LAPSCF+DCF+LAPSCF in a transmission span. This transmission line configuration is suitable for a whole Raman amplification method which is a distributed amplification method, and details of this point are described in [Non-patent literature 3]. On the other hand, in case that the amplification method is a concentrated amplification method as the same as a conventional erbium doped fiber amplifier (EDFA), good transmission characteristics are obtained in case of performing connection in order of LAPSCF+DCF+LAPSCF+DCF in each transmission span because the optical power of a signal in a DCF which is larger in nonlinearity in comparison with LAPSCF can be kept low. In case of a double-hybrid span configuration as shown in FIG. 11, since a distributed amplification method and a concentrated amplification method are different in position of arranging an amplifier from each other, it is a problem that it is not easy to perform optimization of a transmission line configuration which is needed due to change of the above-mentioned two amplification methods.

Further, as the second problem, it is mentioned that the whole optical transmission system is lowered in reliability due to that it is necessary to have a plural types of fibers to form the transmission span, and joints at which different types of fibers are connected each other take place at many points in a transmission span of a transmission line. For example, the double-hybrid span configuration which is shown in FIG. 11 results in having as many as three joints in a transmission span.

### SUMMARY OF THE INVENTION

It is therefore an object of the present invention to provide an optical transmission line which is easy in optimization of a transmission line configuration needed due to change of an amplifying means. At the same time, it provides an optical transmission system realizing a high-speed and long-distance transmission by means of a comparatively simple and high-reliability transmission line configuration.

According to the present invention, there is provided an optical transmission line for transmitting an optical signal from an optical transmitter to an optical receiver comprising a plurality of optical amplification repeaters distributed in said optical transmission line; wherein said optical transmission line is partitioned into a plurality of spans by said plurality of optical amplification repeaters; a transmission span, in which a transmission line fiber for transmitting an optical signal is arranged out of said plurality of spans, is provided with a plurality of dispersion compensation elements for compensating for wavelength dispersion caused by said transmission line fiber, said dispersion compensation elements substantially not adding to a length of a span in which it is located; and one of said plurality of dispersion compensation elements is arranged in said optical amplification repeater.

According to first aspect of the present invention, since one of said plurality of dispersion compensation elements substantially not increasing the span length is arranged in said optical amplification repeater, the optimum transmission line configuration can be realized for each of two amplification methods by simply changing the relative position of arrangement of a dispersion compensation element provided in an optical amplification repeater relative to the two amplifying means of concentrated amplification and distributed amplification. The optimization of a transmission line configuration needed due to change of an amplifying means can be easily performed.

Further the present invention, a single type of fiber to form a transmission line is enough and the number of spots where different kinds of fibers are connected to each other is reduced in a transmission span, thereby the whole optical transmission line is improved in reliability.

An optical transmission system according to the invention comprises an optical transmission line according to the appended claims.

### BRIEF DESCRIPTION OF THE DRAWINGS

FIG. 1 is a diagram showing an embodiment of an optical transmission system applying to an optical transmission line according to the present invention.

FIG. 2(A) is a diagram showing a first embodiment having a span configuration of transmission span 30. FIG. 2(B) is a corresponding dispersion map in an optical transmission span according to the present invention.

FIG. 3(A) is a diagram showing a second embodiment having a span configuration of transmission span 30. FIG. 3(B) is a corresponding dispersion map in an optical transmission span according to the present invention.

FIG. 4(A) is a diagram showing a third embodiment having a span configuration of transmission span 30. FIG. 4(B) is a corresponding dispersion map in an optical transmission span according to the present invention.

FIG. 5(A) is a diagram showing a fourth embodiment having a span configuration of transmission span 30. FIG. 5(B) is a corresponding dispersion map in an optical transmission system according to the present invention.

FIG. 6(A) is a diagram showing an example of a configuration intensively arranging dispersion compensation elements. FIG. 6(B) is a corresponding dispersion map in a transmission span 30.

FIG. 7(A) is a diagram showing another example of a configuration intensively arranging dispersion compensation elements. FIG. 7(B) is a corresponding dispersion map in a transmission span 30.

FIG. 8 is a diagram showing the result of simulation of a 40-Gpbs WDM transmission in the respective transmission span configurations of FIGS. 3(A), 5(A), 6(A) and 7(A). The abscissa indicates a transmission distance and the ordinate indicates a transmission penalty.

FIG. 9(A) to (D) are a diagram showing eye patterns after propagation of 6,000 km obtained by the transmission simulation of FIG. 8.

FIG. 10 is a diagram showing dispersion maps in transmission spans in transmission line configurations disclosed in conventional techniques, and (A), (B), (C) and (D) correspond respectively to the conventional techniques disclosed in [Non-patent literature 1], [Non-patent literature 2], (Patent literature 1] and [Non-patent literature 3].

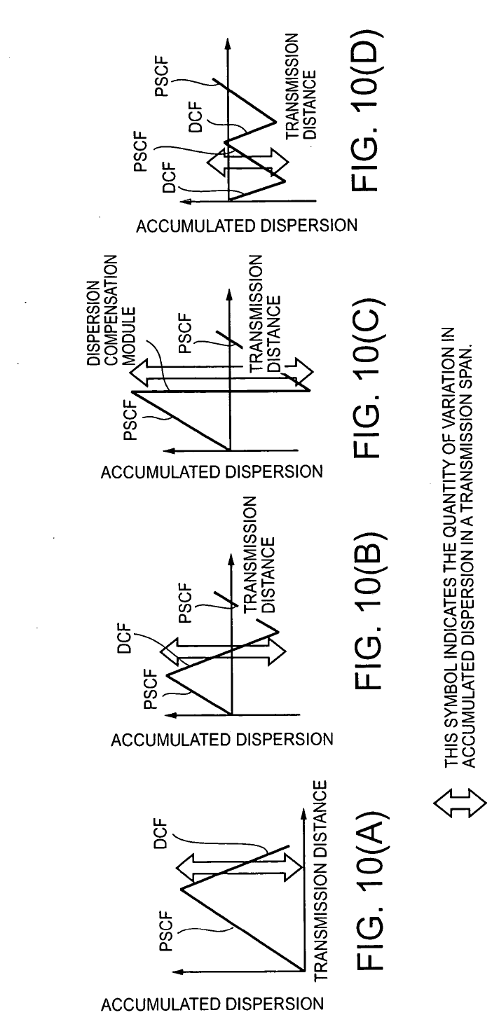

FIG. 11(A) is a diagram showing a span configuration of transmission span 30. FIG. 11(B) is a corresponding dispersion map in the conventional technique disclosed in [Non-patent literature 3].

### DETAILED DESCRIPTION OF THE INVENTION

Next, embodiments of the present invention are described with reference to the drawings.

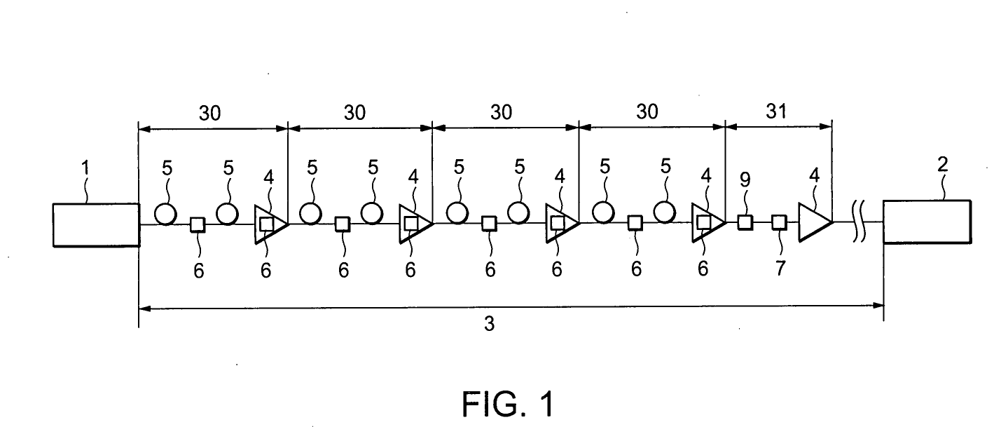

Referring to FIG. 1, an embodiment of an optical transmission system of the present invention is provided with an optical transmitter 1 as well as an optical receiver 2. The optical transmitter 1 and the optical receiver 2 are connected with each other through an optical transmission line 3. A plurality of optical amplification repeaters 4 are distributed in the optical transmission line 3, which is provided with a plurality of dispersion compensation elements 6. The optical transmission line 3 is partitioned into a plurality of spans 30 and 31 by the plurality of optical amplification repeaters 4. Span 30 shows a transmission span containing a transmission line fiber 5 for transmitting an optical signal and span 31 shows a span not containing a transmission line fiber 5 for transmitting an optical signal.

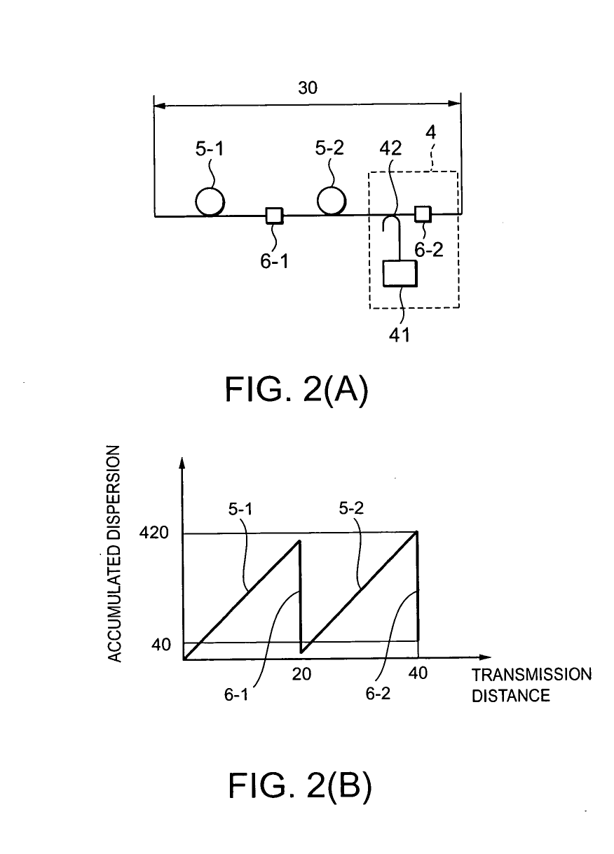

A first embodiment of a transmission span 30 is described in more detail with reference to FIG. 2. As shown in FIG. 2(A), the transmission span 30 is provided with two transmission line fibers 5-1, 5-2 and two dispersion compensation elements 6-1, 6-2 for compensating for wavelength dispersion generated by the transmission line fibers 5-1, 5-2. And an optical amplification repeater 4 is connected to a terminal of the transmission span 30 for compensating for the loss generated by the transmission line fibers 5-1, 5-2 and the dispersion compensation elements 6-1, 6-2. The dispersion compensation element 6-1 is arranged between the two transmission line fibers 5-1 and 5-2, and the dispersion compensation element 6-2 is arranged inside the optical amplification repeater 4. The optical amplification repeater 4 is provided with an excitation light source 41 for performing a backward excitation Raman amplification and a WDM coupler 42 for inputting an excited light generated from the excitation light source 41 into the transmission line fiber 5-2. An optical signal is amplified by the said excited light in the transmission line fibers 5-1 and 5-2.

A large A_{eff} pure silica core fiber (LAPSCF) is used for the transmission line fibers 5-1 and 5-2. The LAPSCF is +20 ps/nm/km in wavelength dispersion value, 200 μm² in effective core sectional area and 0.175 dB/km in transmission loss. The transmission line fiber 5-1 is 20 km in length and the transmission line fiber 5-2 is 20 km in length. And a small device which is not substantially added as transmission distance is used as the dispersion compensation element 6-1 or 6-2. In this embodiment, a dispersion compensation fiber (DCF) wound around a bobbin is used. The DCF is −400 ps/nm/km in wavelength dispersion value, 15 μm² in effective core sectional area and 0.3 dB/km in transmission loss. The length of the DCF is 0.95 km. Due to this, the wavelength dispersion value provided by the dispersion compensation elements 6-1 and 6-2 is −380 ps/nm. A dispersion map in the span is as shown in FIG. 2(B) and the maximum quantity of variation in accumulated dispersion in the span is 420 ps/nm.

In FIG. 1, a gain equalizer 9 for compensating for the unevenness of gain generated in an optical amplification repeater 4 and a dispersion compensation element 7 for compensating for the dispersion left without compensation in a transmission span 30 nearly to zero are arranged in a transmission span 31 having no transmission optical fiber arranged in it out of five transmission spans.

In case that an amplifying means in the optical amplification repeater 4 makes distributed amplification as the same as the first embodiment of a transmission span 30 shown in FIG. 2, it is desirable that a WDM coupler 42 is arranged before a dispersion compensation element 6-2 provided in the optical amplification repeater 4. By performing such an arrangement, it is possible to reduce noises caused by amplification and obtain good transmission characteristics in an optical receiver 2.

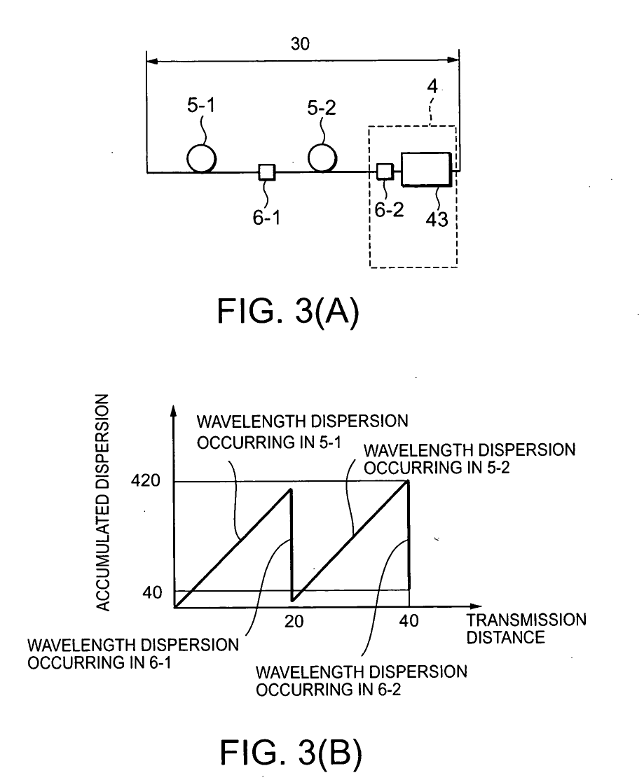

On the other hand, as a second embodiment of a transmission span 30 according to the present invention, in case that an amplifying means in the optical amplification repeater 4 makes concentrated amplification, it is desirable that a concentrated amplifier 43 is arranged behind a dispersion compensation element 6-2 provided in the optical amplification repeater 4, as shown in FIG. 3. By performing such an arrangement, it is possible to reduce the optical power of an optical signal in a dispersion compensation element being generally larger in nonlinearity in comparison with a transmission line fiber and to obtain good transmission characteristics. In such a way, since the optimum transmission line configuration for each of said two amplification methods of said two amplifying means can be realized by only changing the relative position of arrangement of a dispersion compensation element 6-2 provided in said optical amplification repeater 4, it is easy to perform the optimization of a transmission line configuration which is needed due to change of an amplifying means.

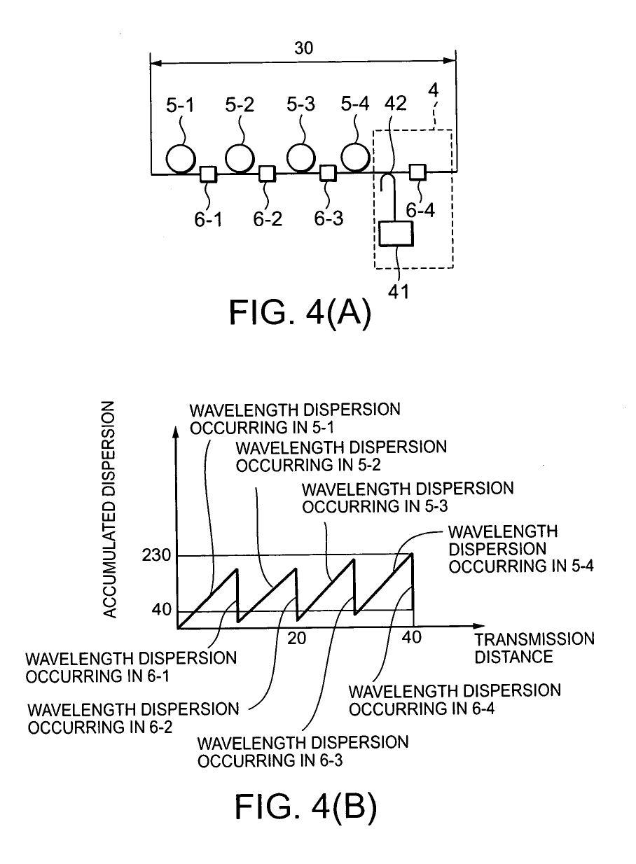

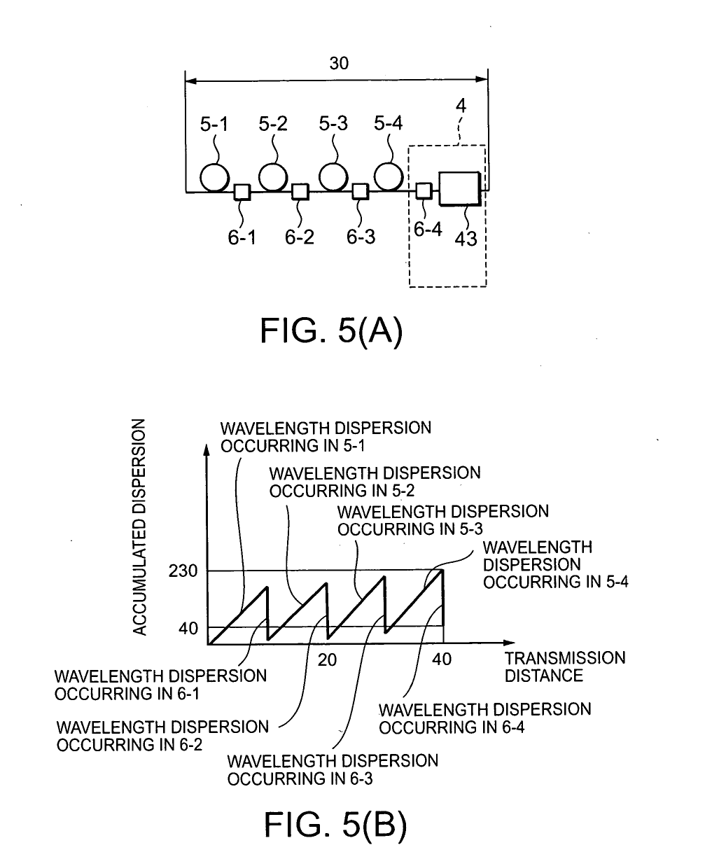

As shown in FIGS. 4 and 5, third and fourth embodiments of a transmission span 30 in an optical transmission system according to the present invention may be a system configuration having four dispersion compensation elements in total distributed in a transmission span 30.

It is desirable that a transmission line fiber used in the present invention is a single type of fiber which is 100 μm² in effective core sectional area.

And in a preferable configuration according to the present invention, a DCF which is −200 ps/nm/km or less in dispersion value is used as the dispersion compensation elements 6-1 and 6-2. Such a DCF enables the dispersion compensation element to be made small-sized thanks to short length in fiber length.

And as a preferable embodiment according to the present invention, the maximum quantity of variation in accumulated dispersion in a span becomes 500 ps/nm/km or less. In many cases, such a configuration is realized by distributing a plurality of dispersion compensation elements in a span as shown in the present invention.

An effect provided by such an arrangement is described on the basis of a result of transmission simulation shown in the following. This transmission simulation multiplexed optical signals of 42.7 Gbps in bit rate in five channels and evaluated a transmission penalty in the middle channel. The frequency interval between channels was 100 GHz and a polarization interleave multiplex method orthogonalizing and inputting polarized waves of adjacent channels in a transmission line was used. As a transmission line fiber, LAPSCF was used. As a dispersion compensation element, DCF was used. As an amplifying means, EDFA was used, and the optical power of a signal after being outputted from the. EDFA was made −2 dBm/ch in each channel. The sum of dispersion values of PSCF and a dispersion compensation element (DCF) in a transmission span was made +40 ps/nm and in this case, a configuration compensating for the remaining dispersion in each 5-span transmission was adopted.

This transmission simulation compared transmission characteristics of the four transmission line configurations of FIGS. 3, 5, 6 and 7 with one another.

FIG. 3 shows a configuration in which two transmission line fibers and two dispersion compensation elements are arranged in a transmission span and the dispersion compensation elements are arranged respectively between two transmission line fibers and directly before an amplifying means in an optical amplification repeater. At this time, the quantity of variation in accumulated dispersion in a transmission span becomes 420 ps/nm. This configuration is the same as the configuration shown in this embodiment.

FIG. 5 shows a configuration in which four transmission line fibers and four dispersion compensation elements are arranged in a transmission span and the dispersion compensation elements are arranged respectively between the transmission line fibers and directly before an amplifying means in an optical amplification repeater. At this time, the quantity of variation in accumulated dispersion in a transmission span becomes 230 ps/nm. This configuration shows another embodiment according to the present invention.

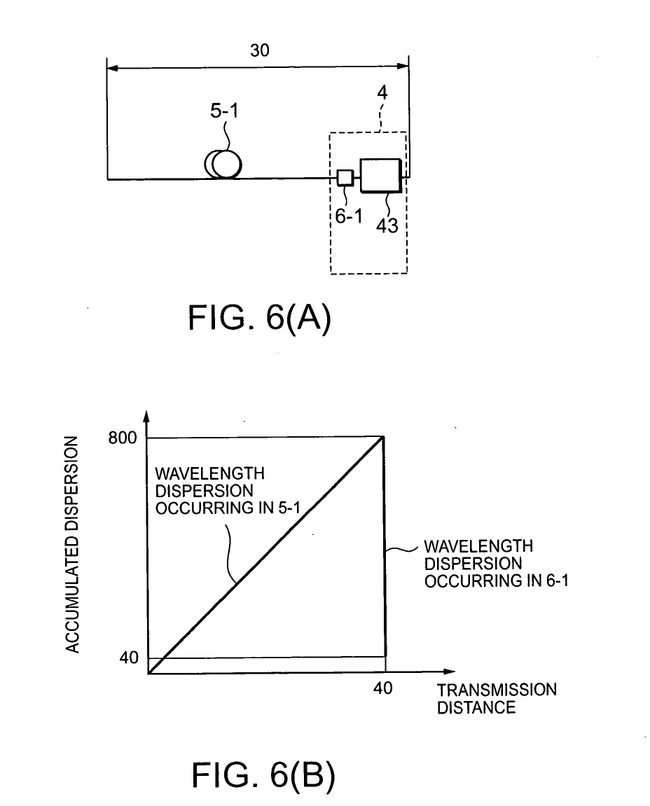

FIG. 6 shows a configuration in which one transmission line fiber and one dispersion compensation element are arranged in a transmission span and the dispersion compensation element is arranged directly before an amplifying means in an optical amplification repeater. At this time, the quantity of variation in accumulated dispersion in a transmission span becomes 800 ps/nm.

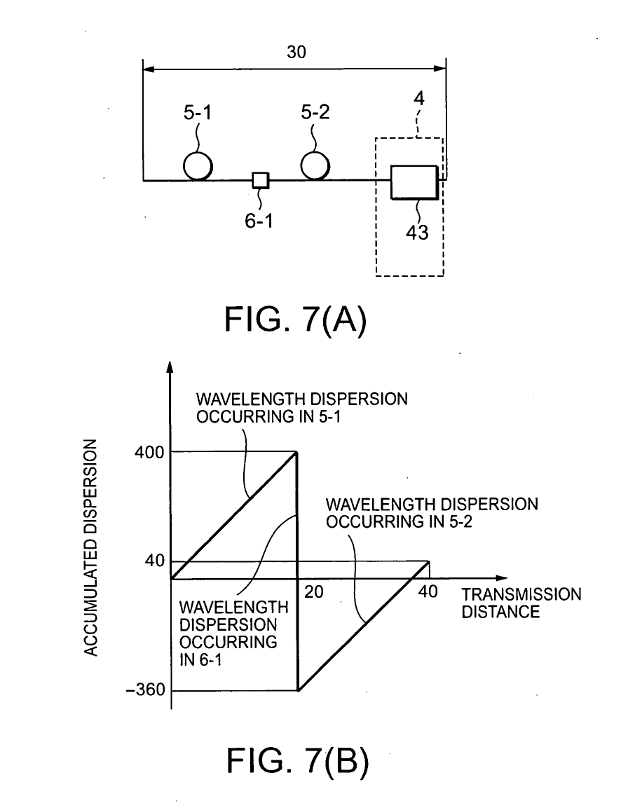

FIG. 7 shows a configuration in which two transmission line fibers which are equal in length to each other and one dispersion compensation element are arranged in a transmission span and the dispersion compensation element is arranged between the two transmission line fibers. At this time, the quantity of variation in accumulated dispersion in a transmission span becomes 760 ps/nm. This configuration is the same as a configuration disclosed in [Patent literature 1].

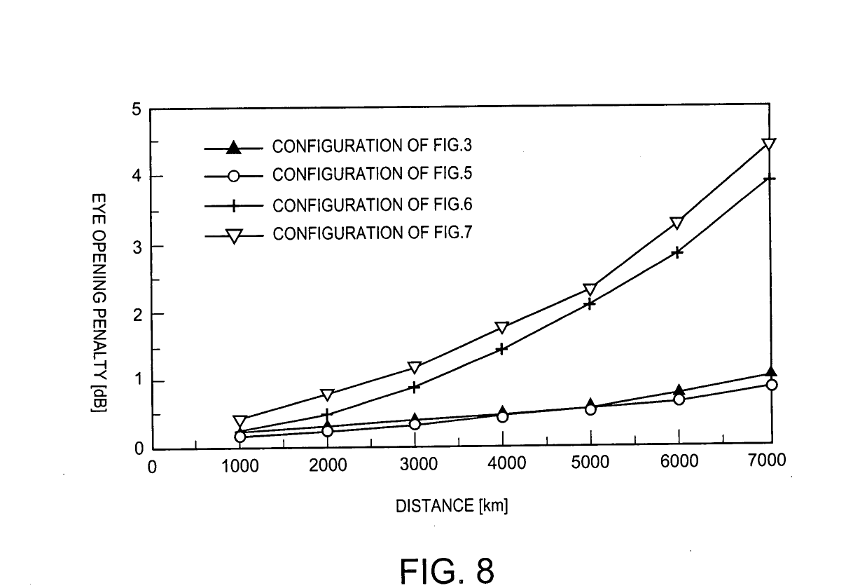

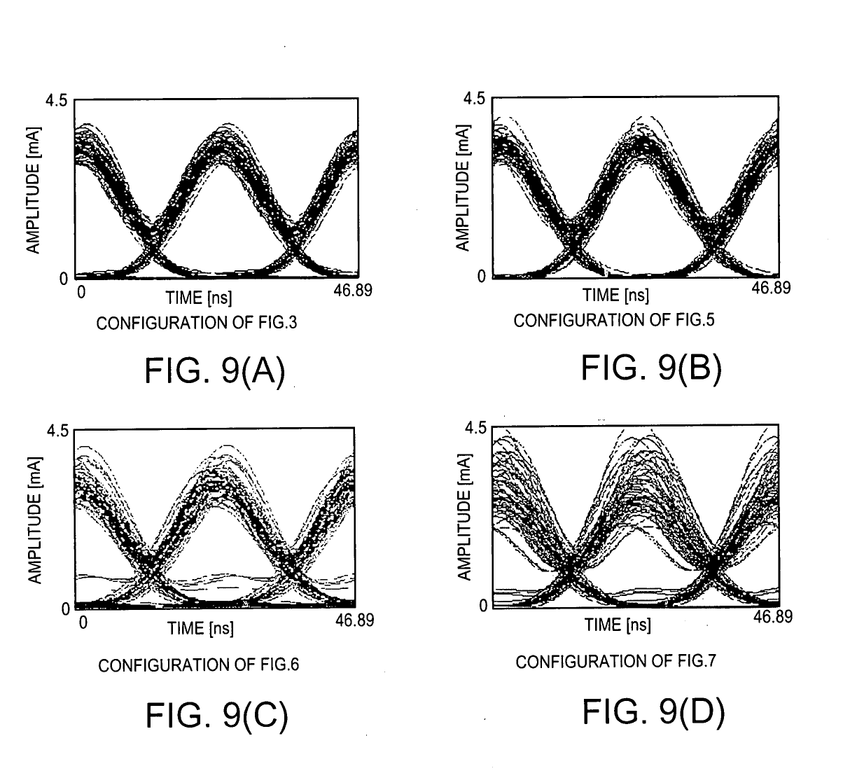

FIG. 8 shows the result of transmission simulation. In FIG. 8, the abscissa indicates a transmission distance and the ordinate indicates a transmission penalty. It is desirable that a transmission penalty is suppressed to be 1.5 dB or less. And FIG. 9 shows an eye pattern after propagation of 6,000 km in each configuration.

In the configurations of FIGS. 3 and 5 in which the quantity of variation in accumulated dispersion in a transmission span is suppressed to 500 ps/nm or less, a transmission penalty is kept low even in a long-distance transmission, but in the configurations of FIGS. 6 and 7 in which the quantity of variation in accumulated dispersion in a transmission span becomes 500 ps/nm or more, a transmission penalty exceeds the tolerance of 1.5 dB in the vicinity of a transmission distance of 4,000 km.

Also, in the eye patterns shown in FIG. 9, the configurations of FIGS. 3 and 5 provide good eye openings. From this data, it is understood that good transmission characteristics are given by making an accumulated dispersion value in a transmission span be 500 ps/nm or less.

The first to fourth embodiments of the present invention leave dispersion of +20 ps/nm as wavelength dispersion values of dispersion compensation elements 6-1 and 6-2 without performing compensation to the extent of making completely zero the quantity of wavelength dispersion in a transmission line fiber arranged before each dispersion compensation element. The reason for such a configuration being adopted is to reduce the deterioration in waveform caused by the cross phase modulation (XPM) between adjacent channels in addition to SPM in case of performing a WDM transmission.

In a preferred embodiment according to the present invention, the absolute value of the sum of the total wavelength dispersion value of transmission line fibers 5-1, 5-2 and the total wavelength dispersion value of dispersion compensation elements 6-1, 6-2 is not less than 20 ps/nm and not more than 60 ps/nm.

As described above, an optical transmission system of the present invention exhibits the following effects.

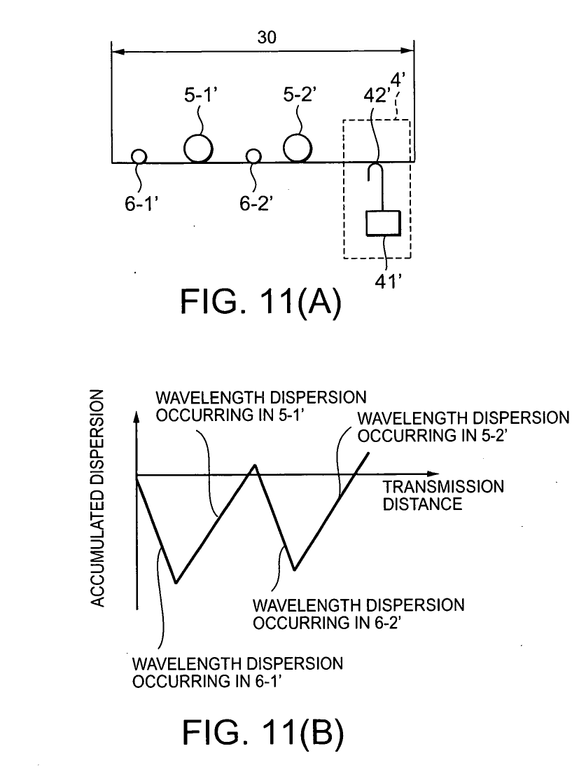

The first effect is that the above-noted problem of having plural types of fibers to form a transmission span is solved. In short, according to the present invention, a single type of fiber to form a transmission line is enough and the number of joints where different kinds of fibers are connected to each other is reduced in a transmission span, and thereby the whole optical transmission system is improved in reliability. Comparing a technique according to the present invention shown in FIG. 2 with a conventional technique disclosed in [Non-patent literature 3] shown in FIG. 11, while the conventional technique has two types of fibers in a transmission line, the technique according the present invention permits the use of substantially only one kind of fibers in a transmission line. And while the conventional technique has three joints in which different kinds of fibers are connected to each other in the transmission line, according to the present invention there need be only one joint.

The second effect according to the present invention is that the above-noted problem of making it difficult to perform the optimization of a transmission line configuration needed due to change of an amplifying means is solved. In short, since the optimum transmission line configuration can be realized for each of two amplification methods by simply changing the relative position of arrangement of a dispersion compensation element provided in an optical amplification repeater relative to the two amplifying means of concentrated amplification and distributed amplification, the optimization of a transmission line configuration needed due to change of an amplifying means can be easily performed.

As shown above, the present invention provides an optical transmission system capable of realizing a high-speed and long-distance transmission by means of a comparatively simple and high-reliability transmission line configuration. At the same time, it provides an optical transmission system which is easy in optimization of a transmission line configuration needed due to change of an amplifying means.

It will be obvious to those having skill in the art that many changes may be made in the above-described details of the preferred embodiments of the present invention. The scope of the present invention, therefore, should be determined by the following claims.

What is claimed is:

1. An optical transmission line for transmitting an optical signal from an optical transmitter to an optical receiver, comprising
a plurality of optical amplification repeaters distributed in said optical transmission line;
wherein said optical transmission line is partitioned into a plurality of transmission spans by said plurality of optical amplification repeaters;
at least one of said transmission spans is provided with a plurality of dispersion compensation elements for compensating for wavelength dispersion caused by said transmission line fiber, said dispersion compensation elements substantially not adding to a length of said span; and
at least one of said plurality of dispersion compensation elements is arranged in said optical amplification repeater.

2. An optical transmission line according to claim 1, wherein:
said optical amplification repeater is provided with a concentrated amplifier for intensively amplifying optical signals in it, and
said concentrated amplifier is arranged behind a dispersion-compensating element arranged in said optical amplification repeater.

3. An optical transmission line according to claim 1, wherein:
said optical amplification repeater is provided with an excitation light source for distributed-amplifying an optical signal and an excited light input means for inputting said excited light into said transmission line fiber, and
said excited light input means is arranged before a dispersion compensation element arranged in said optical amplification repeater.

4. An optical transmission line according to claim 1, wherein said transmission line fiber is a single kind of fiber being 100 μm² or more in effective core sectional area.

5. An optical transmission line according to claim 1, wherein said dispersion compensation element is a dispersion compensation fiber being −200 ps/nm/km or less in dispersion value.

6. An optical transmission line according to claim 1, wherein the quantity of variation in accumulated dispersion of said transmission span is 500 ps/nm or less.

7. An optical transmission line according to claim 1, wherein the absolute value of the sum of the total wavelength dispersion value of said transmission line fiber and the total wavelength dispersion value of said plurality of dispersion compensation elements is not less than 20 ps/nm and not more than 60 ps/nm.

8. An optical transmission system comprising an optical transmission line according to claim 1.

9. An optical transmission system comprising an optical transmission line according to claim 2.

10. An optical transmission system comprising an optical transmission line according to claim 3.

11. An optical transmission system comprising an optical transmission line according to claim 4.

12. An optical transmission system comprising an optical transmission line according to claim 5.

13. An optical transmission system comprising an optical transmission line according to claim 6.

14. An optical transmission system comprising an optical transmission line according to claim 7.
